(19) United States
(12) Patent Application Publication
(10) Pub. No.: US 2010/0183952 A1
(43) Pub. Date: Jul. 22, 2010

(54) FUEL CELL GAS SEPARATOR FOR USE BETWEEN SOLID OXIDE FUEL CELLS

(76) Inventors: Sudath D. Kumara Amarasinghe, Berwick (AU); Sathia Kumar Aruliah, Wheelers Hill (AU); Stephen G. Phillip, Hawthorn (AU)

Correspondence Address: BIRCH STEWART KOLASCH & BIRCH, PO BOX 747, FALLS CHURCH, VA, 22040-0747, US

(21) Appl. No.: 12/440,118

(22) PCT Filed: Sep. 6, 2007
(86) PCT No.: PCT/AU2007/001318

§ 371 Date: Mar. 15, 2010

(30) Foreign Application Priority Data
Sep. 6, 2006 (AU) 2006904888

(51) Int. Cl. H01M 2/14

(52) U.S. Cl. 429/514

(57) ABSTRACT

A fuel cell gas separator (112) for use between two solid oxide fuel cells (110), the gas separator having a separator body (146) with an anode side and a cathode side and with paths (134) of electrically conductive material therethrough from the anode side to the cathode side in an electrode contacting zone of the separator, the electrically conductive material being Ag or a silver-containing material, an anode side coating over the electrode contacting zone comprising an anode side current collector layer (158), and a cathode side coating over the electrode contacting zone comprising a cathode side current collector layer (152), and a respective silver-barrier patch (156) directly or indirectly overlies each path of electrically conductive material on the anode side, each silver-barrier patch being sufficiently dense to prevent diffusion of Ag therethrough. In another aspect, each silver-barrier patch is offset from the paths of electrically conductive material, but still perform the function of preventing Ag that may escape from the paths of poisoning the catalytic activity of the anode. In yet another aspect, the gas separator prevents oxygen on the cathode side reaching the anode side via the paths of electrically conductive material.

### FIELD OF THE INVENTION

The present invention relates to solid oxide fuel cells, and is particularly concerned with gas separators for use therewith.

### BACKGROUND OF THE INVENTION

The purpose of a gas separator in a solid oxide fuel cell assembly is to keep the oxygen-containing gas supplied to the cathode side of one fuel cell separate from the fuel gas supplied to the anode side of an adjacent fuel cell, and to conduct heat generated in the fuel cell away from the fuel cells. The gas separator may also conduct electricity generated in the fuel cells between or away from the fuel cells. Although it has been proposed that this function may alternatively be performed by a separate member between each fuel cell and the gas separator, much development work has been carried out on electrically conductive gas separators.

Some of that development work has been described briefly in the background discussions of the applicant's International Patent Applications WO 03/007403 and WO 03/073533, the contents of which and of their corresponding U.S. patent application Ser. Nos. 10/482,837 and 10/501,153 are incorporated herein by reference. Those patent applications are each directed to a fuel cell gas separator for use between two solid oxide fuel cells, the gas separator having a separator body with an anode side and a cathode side and with paths of electrically conductive material therethrough from the anode side to the cathode side in an electrode contacting zone of the separator, the electrically conductive material being Ag or a silver-based material, and an anode side coating over the electrode contacting zone comprising a current collecting layer and a cathode side coating over the electrode contacting zone comprising a current collecting layer. The present invention is also especially concerned with such a gas separator.

As described in WO 03/007403 and WO 03/073533, other disclosures of fuel cell gas separators having paths therethrough of more electrically conductive material than the separator body include EP-A-0993059, US-A 20020068677 and Kendall et al. in Solid Oxide Fuel Cells IV, 1995, pp. 229-235. U.S. Pat. No. 5,827,620 is an equivalent patent disclosure, at least in part, to the Kendall et al. paper.

Silver, either alone or in some form of composite, is a highly effective material for the paths of electrically conductive material through the separator body because of its relatively high electrical conductivity and because of its compliance in a range of temperatures, particularly under the high temperature operating conditions (700° C. to 1100° C.) of a solid oxide fuel cell assembly.

Traditionally, hydrogen, usually moistened with steam, has been used as the fuel in fuel cells. However, in order for the fuel cell electricity generation to be economically viable, the fuel must be as cheap as possible. One relatively cheap source of hydrogen is natural gas—primarily methane with a small proportion of heavier hydrocarbons. Natural gas is commonly converted to hydrogen in a steam reforming reaction, but the reaction is endothermic and, because of the stability of methane, requires a reforming temperature of at least about 650° C. for substantial conversion, and a higher temperature for complete conversion. While solid oxide fuel cell systems operate at high temperatures and produce heat which must be removed, heat exchangers capable of transferring thermal energy at the required level of at least about 650° C. from the fuel cells to a steam reformer are expensive. Thus, hydrogen produced entirely by externally steam reformed natural gas may not be a cheap source of fuel for fuel cells.

In order to provide hydrogen for the fuel cell reaction more economically, it has been proposed to partially reform natural gas on the anodes of solid oxide fuel cells, using catalytically active anode material such as nickel. One such process is described in the applicant's International Patent Application WO 02/067351, and its US equivalent U.S. Pat. No. 6,841,279.

One of the problems associated with the use of silver on the anode side of a solid oxide fuel cell gas separator, for example in the paths of electrically conductive material or as at least part of an anode side coating of electrically conductive material, as described in WO 03/007403 and WO 03/073533, is that the silver can be very mobile at the elevated operating temperature of the fuel cell system. Thus the silver can be transported with the fuel gas onto the anode of the adjacent fuel cell, where it may poison the catalytic activity of the anode and inhibit the internal reforming action of the fuel gas on the anode.

Another problem associated with the use of silver in paths of electrically conductive material through a gas separator for use between two solid oxide fuel cells is that silver has a high diffusion rate for dissolved oxygen at the elevated temperatures of operation of a solid oxide fuel cell assembly. This means that when silver is used in the paths of electrically conductive material, oxygen from the oxidant can be transported via the paths from the cathode side of the gas separator to the anode side, where the oxygen can react with hydrogen from the fuel gas. Such a reaction liberates steam and heat, both of which in the paths of electrically conductive material can cause openings between the silver grain boundaries. Such openings result in an increase in the diffusion rate and may ultimately lead to failure of the gas separator.

It would be advantageous to alleviate one or more of the disadvantages of silver associated with a gas separator used between adjacent solid oxide fuel cells.

### SUMMARY OF THE INVENTION

According to a first aspect of the present invention, there is provided a fuel cell gas separator for use between two solid oxide fuel cells, the gas separator having a separator body with an anode side and a cathode side and with paths of electrically conductive material therethrough from the anode side to the cathode side in an electrode contacting zone of the separator, the electrically conductive material being Ag or a silver-containing material, an anode side coating over the electrode contacting zone comprising a current collector layer and a cathode side coating over the electrode contacting zone comprising a current collector layer, and wherein a respective silver-barrier patch overlies each path of electrically conductive material on the anode side, each silver-barrier patch being sufficiently dense to prevent diffusion of Ag therethrough.

By this aspect of the invention, the problem of Ag poisoning the anode in a solid oxide fuel cell is alleviated by providing a respective silver-barrier patch overlying, directly or indirectly, each path of electrically conductive material on the anode side. The silver-barrier patch at least reduces the escape of Ag from the respective path of electrically conductive material through the anode side coating into the fuel gas flow path between the gas separator and the adjacent fuel cell anode. Preferably, each silver-barrier patch is fully dense. Diffusion of Ag through each silver-barrier patch should be prevented through the operating range of the solid oxide fuel cells with which the gas separator is used.

By the term “electrode contacting zone” as used throughout this specification is meant the portion of the gas separator that is opposed to and aligned with the respective electrode of the adjacent fuel cell. Any contact of the electrode contacting zone with the adjacent electrode may be indirect, through interposed current collection and/or gas flow control devices. It will be understood therefore that the use of the term “electrode contacting zone” does not require that zone of the gas separator to directly contact the adjacent electrode.

One or more of the paths of electrically conductive material, preferably all of them, may each have an enlarged head on the anode side of the separator body, preferably of up to 50 times the cross-sectional area of the portion of the path through the separator body, more preferably 20 to 40 times, for example about 30 times. The head may be integrally formed with the electrically conductive material in the path, but is preferably formed separately. In either case, references hereinafter to the paths of electrically conductive material through the separator body shall generally be understood to include reference to the preferred enlarged head on the anode side. The purpose of the enlarged head is to reduce the electrical resistance between the portion of the path of electrically conductive material within the separator body and the adjacent anode side structure. The material of the enlarged head should be at least as electrically conductive as, and is preferably more electrically conductive than, the material of the portion of the path of electrically conductive material within the separator body, and is advantageously commercially pure silver. The enlarged head may have a thickness in the range of, for example, 20 to 100 μm, preferably 30 to 50 μm.

Each silver-barrier patch must extend beyond the contour of the respective path of electrically conductive material, including any enlarged head on the anode side, in order to alleviate the risk of silver diffusing around it. Preferably, the silver-barrier patch has a cross-sectional area of 1.5 to 5 times or more that of the respective path of electrically conductive material including any enlarged head, more preferably 2 to 4 times.

At least one silver-barrier patch may directly overlie the respective path of electrically conductive material, in contact therewith, in which case it may be engaged with the separator body around the path of electrically conductive material. In this case, the silver-barrier patch must be electrically conductive to enable electrical current from the path of electrically conductive material to pass to or from the anode side current collector layer. There are few materials that can perform the required functions, under the operating conditions of a solid oxide fuel cell system, of preventing the diffusion of silver from the path of electrically conductive material and conducting electrical current. A preferred option is a nickel/glass composite blended in a ratio to provide a suitable balance between the silver barrier property and electrical conductivity. Such a ratio may be in the range of 5 to 50 wt % by weight nickel, preferably 10 to 30 wt % nickel, with the remainder being glass. In this embodiment, the composite is preferably formed from a blend of nickel powder of ≧99.9% purity and powdered viscous type glass. The preferred nickel and glass powders may conveniently have particle sizes up to about 100 μm, preferably in the range 5 to 75 μm. The blend is sintered at a suitable temperature. In one embodiment, the blend is sintered during the initial operation of a fuel cell stack incorporating the separator, for example at a temperature in the range of 800 to 850° C. Preferably the glass is a high silica viscous glass, for example with a composition in wt % selected from any of Glass Types 1, 4 and 5 in Table 1 hereinafter.

Other suitable materials for the silver-barrier patch that may provide the two desired functions in this embodiment include highly active or spherical nickel on its own and sintered to provide the required density, for example at a temperature in the range of 800 to 850° C. in the manner described above, and high purity (≧99.9%) nickel applied as a foil. The nickel in any of these conductive silver-barrier patch materials may be replaced by, or be alloyed with, one or more non-Ag noble metals. However, this is not preferred due to the expense of non-Ag noble metals.

In an alternative embodiment of this aspect, each silver-barrier patch overlies (that is, is aligned with and overlaps) the respective path of electrically conductive material, including any enlarged head on the anode side, and therefore may have the aforementioned dimensions, but is separated from the path of electrically conductive material by a layer of the anode side coating. Thus, the silver-barrier patch may be disposed, for example, on the surface of the anode side current collector layer remote from the separator body. Although the silver-barrier patch is spaced from the path of electrically conductive material, it has been found to be effective in alleviating the diffusion of Ag from that electrically conductive material. However, in this embodiment, it is not essential for the silver-barrier patch to be electrically conductive, and the patch may alternatively be formed of a dense viscous or crystalline glass selected from, for example, any of Glass Types 1 to 5 in Table 1. The processing of the glass may be as described above for the glass of the preferred nickel/glass composite electrically conductive silver-barrier patch.

In either embodiment in this aspect, the silver-barrier patch may have a thickness in the range of about 50 to 150 μm, preferably about 75 to 125 μm. The silver-barrier patch should be sufficiently thick to provide an effective barrier, but not so thick as to detrimentally affect the function of the gas separator and fuel cell assembly.

According to a second aspect of the invention, there is provided a fuel cell gas separator for use between solid oxide fuel cells, the gas separator having a separator body with an anode side and a cathode side and with paths of electrically conductive material therethrough from the anode side to the cathode side in an electrode contacting zone of the separator, the electrically conductive material being Ag or a silver-containing material, an anode side coating over the electrode contacting zone comprising a current collector layer and a cathode side coating over the electrode contacting zone comprising a current collector layer, wherein the anode side coating further comprises a gas barrier layer beneath said anode side current collector layer and an electrically conductive underlayer between said gas barrier layer and the separator body, said gas barrier layer being formed of a material that is less electrically conductive than the anode side current collector layer and the electrically conductive underlayer and having relatively electrically conductive passages therethrough from the anode side current collector layer to the electrically conductive underlayer which are offset relative to the paths of electrically conductive material through the separator body, wherein the electrically conductive underlayer electrically connects all of the paths of electrically conductive material through the separator body with all of the electrically conductive passages through the gas barrier layer, and wherein a respective silver-barrier patch is associated with each of said relatively electrically conductive passages through said gas barrier layer, each silver-barrier patch being sufficiently dense to prevent diffusion of Ag therethrough.

By this aspect of the invention, the problem of Ag poisoning the anode in a solid oxide fuel cell is alleviated by providing a respective silver-barrier patch associated with each passage through the gas barrier layer. Furthermore, the gas barrier layer acts as a barrier to oxygen and alleviates the risk of oxygen that diffuses through the paths of electrically conductive material reacting with hydrogen on the anode side of the gas separator. Preferably, each silver-barrier patch is fully dense and has features as described with respect to the first aspect of the invention except that it need not be electrically conductive.

The available materials for the gas barrier layer in the solid oxide fuel cell environment are limited, and a currently preferred material is glass. The glass may be viscous glass, crystalline glass or a mixture of viscous and crystalline glasses selected from, for example, any one or more of Glass Types 1 to 5 in Table 1. In a particularly preferred embodiment, the glass is provided in two layers, one of a viscous glass such as of Glass Type 1 or 4 in Table 1 and the other a crystalline glass such as of Glass Types 2 or 3 in Table 1. Preferably, the viscous glass layer is closest to the gas separator body and is primarily responsible for providing the gas barrier properties, while the crystalline layer may provide a harder “skin” to the viscous layer and alleviate interaction between the viscous layer and the adjacent current collector layer of the anode side coating. Processing parameters for the glass layer or layers may be as described herein for other preferred glass components of the gas separator. The preferred two glass layers may be formed from powdered glass as described above and be sintered separately to the running of the fuel cell assembly, for example at a temperature of about 900° C.

The gas barrier layer extends over the whole of the electrode contacting zone of the separator body, and the material of the gas barrier layer must be sufficiently dense and thick to prevent or minimise the passage of oxygen or hydrogen therethrough. Preferably, it is fully or 100% dense and has a thickness in the range 40 to 120 μm, more preferably 60 to 100 μm. Where the gas barrier layer comprises two glass layers, each preferably has a thickness in the range of 30 to 50 μm.

The relatively electrically conductive passages through the gas barrier layer of the gas separator of the second aspect of the invention are provided because the material of the gas barrier layer is insufficiently electrically conductive. The electrically conductive material in the passages through the gas barrier layer may be, for example, the material of the electrically conductive underlayer or of the current collector layer of the anode side coating, or both. Alternatively, some other acceptable material may be provided, such as that of the silver-barrier patch if it is electrically conductive.

In order to ensure that the gas barrier layer still alleviates the risk of oxygen that diffuses through the paths of electrically conductive material reacting with hydrogen on the anode side, the passages are all offset relative to the paths of electrically conductive material through the separator body so as to increase the oxygen diffusion path. The passages of electrically conductive material through the gas barrier layer should be sufficient in number and cross-sectional area to permit the desired flow of electrical current through the gas barrier layer. In one embodiment, the overall cross-sectional area of the passages of electrically conductive material through the gas barrier layer is substantially the same, that is within about 10%, as the overall cross-sectional area of the paths of the electrically conductive material through the gas separator body (not including the area of any enlarged head on said paths). However, this will depend at least in part on the electrical conductivity of the material in the passages through the gas barrier layer.

With such passages of electrically conductive material through the gas barrier layer offset relative to the paths of electrically conductive material through the separator body, it is necessary for the anode side coating of the gas separator of the second aspect of the invention to include the electrically conductive underlayer between the separator body and the gas barrier layer. The underlayer overlies and is in contact with all of the paths of electrically conductive material through the separator body and in contact with the passages of electrically conductive material through the gas barrier layer. The electrically conductive underlayer extends over the entire electrode contacting zone of the separator and may also provide lateral heat transfer across the surface of the separator body to alleviate stress imparted in the separator body due to temperature variations.

The thickness of the electrically conductive underlayer should be sufficient to provide the desired electrical conductivity between the individual paths of electrically conductive material through the gas separator body and the offset passages of electrically conductive material through the gas barrier layer, but is not otherwise restricted. Preferred thicknesses are in the range of 20 to 100 μm, more preferably 30 to 70 μm.

Preferably the material of the electrically conductive underlayer comprises silver. If used alone, the silver may be in the form of a sintered powder or a foil. The powder may conveniently have particle sizes up to about 100 μm, preferably in the range 5 to 75 μm. A currently preferred material is a sintered silver powder of greater than 99.9% purity and formed from powder having a particle size in the range 5 to 75 μm. Alternatively, suitable silver composites may be used, preferably composites with glass since they may provide enhanced gas barrier properties in the electrically conductive underlayer. Such a silver/glass composite may be similar to that preferably used in the paths of electrically conductive material through the gas separator body and described hereinafter. The silver could be alloyed with, or replaced by, one or more other noble metals. However, this is not preferred due to the expense of the other noble metals. Nickel is not an option for the material of the underlayer due to the risk of oxidation, with a resultant loss of electrical conductivity, by oxygen diffusing through the paths of electrically conductive material through the separator body and insufficient access for fuel to the underlayer to maintain the nickel in its reduced state.

The respective silver-barrier patch associated with each passage through the gas barrier layer is provided in the gas separator of the second aspect of the invention in order to alleviate escape of silver from the anode side of the gas separator. By “associated with” each passage through the gas barrier layer is meant that the silver-barrier patch may directly or indirectly overlie the passage or, if it is sufficiently electrically conductive, may at least partly comprise the electrically conductive material in the passage. Preferably, each such silver-barrier patch is formed of a material and has dimensions (relative to the respective passage) as described for the silver-barrier patch overlying but spaced from each path of electrically conductive material through the gas separator body of the alternative embodiment of the first aspect of the invention.

The paths of electrically conductive material through the separator body in the gas separator of the second aspect of the invention may each have an enlarged head on the anode side of the separator body as described with reference to the first aspect of the invention. However, such an enlarged head may not be necessary where the electrically conductive underlayer is of silver.

Unless specifically stated, the following description is applicable to the gas separator of both the aforementioned aspects of the present invention.

The current collector layer on the anode side conducts electrical current laterally across the surface of the separator body and can also provide lateral heat transfer to alleviate stress induced in the separator body due to temperature variation. It should extend over the entire electrode contacting zone of the separator, and preferably has a thickness in the range of 20 to 100 μm, more preferably 30 to 70 μm. The minimum thickness is required to enable it to perform its lateral electrical current flow and heat transfer functions, but if the layer is too thick it may have a tendency to crack.

There are very few materials that can perform the two functions of lateral electrical current flow and lateral heat transfer under the operating conditions of a solid oxide fuel cell, and the currently preferred material is nickel, sintered from a nickel powder of ≧99.9% purity and a particle size in the range of 5 to 75 μm. Alternatively, the high purity nickel could be in the form of a foil.

Any individual silver-barrier patch that does not directly overlie one of the paths of electrically conductive material through the separator body may be provided at least partly in the anode side current collector layer.

Advantageously, the anode side coating further comprises an outermost compliant layer that extends over at least substantially the entire electrode contacting zone and directly overlies the anode side current collector layer.

The compliant layer is particularly advantageous in absorbing variations in height in the adjacent fuel cell component since any relatively projecting parts of the adjacent component may indent and bed into the compliant layer. In one embodiment, pillars or other individual projections are provided on the anodes of solid oxide fuel cells to facilitate fuel gas flow between the gas separator and the primary surface of the anode, that is the surface of the anodes between the pillars or other projections. The compliant layer permits the projections to vary slightly in height without applying excessive mechanical stress to the gas separator. It has been found that the indenting feature of the compliant layer must be performed by a separate layer to the anode side current collector layer as the latter cannot be formed in such a way as to provide this function and the additional functions of lateral electrical current conduction and lateral heat transfer. Preferably, the compliant layer has a thickness in the range of 100 to 200 μm, more preferably 125 to 175 μm.

The compliant layer must provide electrical conductivity between the anode side current collector layer and the adjacent anode, and the currently preferred material is nickel. In one form, the compliant layer is sintered from a nickel powder of >99.9% purity and particle size in the range of 5 to 75 μm. A pore former is mixed with the nickel powder and burns off when the nickel is sintered on the current collector layer, leaving the desired porous nickel structure. The pore former may be provided in amounts of 10 to 30 wt %, preferably 15 to 20 wt % of the nickel. A suitable pore former is polybutylmethacrylate (PBMA), but other known pore formers may be suitable. Preferably the porosity of the compliant layer is in the range of 10-50 vol %.

Any individual silver-barrier patch that does not directly overlie one of the paths of electrically conductive material through the separator body may be provided at least partly in openings in the compliant layer, and this is what is implied by the compliant layer extending at least substantially over the entire current collector layer. In such an embodiment the individual silver-barrier patches may be provided on the current collector layer in openings in the compliant layer. The patches may be laterally spaced from the edges of the openings in the compliant layer.

The material of the separator body is preferably selected with a co-efficient of thermal expansion (CTE) that substantially matches those of the other fuel cell components, but any suitable material may be selected, including electrically conductive materials such as metals and alloys. In a solid oxide fuel cell assembly in which the electrolyte material of the fuel cells is preferably a zirconia and may be the principal layer that supports the electrode layers, the material of the separator body is advantageously zirconia. The zirconia of the gas separator may be yttria stabilised, for example 3 to 10 wt % yttria. Alternatively or in addition, the zirconia may include other materials while retaining a zirconia based structure. For example, the zirconia may be a zirconia alumina having up to 15 wt %, or even up to about 20 wt %, alumina. The currently preferred material is zirconia stabilised with 10 wt % yttria and strengthened with 2 to 15 wt % alumina. For convenience, all such zirconia based materials are hereinafter referred to as zirconia.

The thickness of the separator body is preferably no more than 500 μm, more preferably substantially less than this in order to minimise the overall thickness or height and mass of a fuel cell stack utilising plural gas separators, for example in the range 50 to 250 μm. While a lesser thickness could be used, the gas separator body becomes difficult to manufacture. It also becomes more difficult to ensure that the material of the separator body is dense, that is that the material is gas tight to the gases in the fuel cell assembly. Greater thicknesses may be used but are unnecessary, and more preferably the thickness is no more than 200 μm.

The separator body may be formed by any suitable means, depending particularly upon the material and the shape of the separator. Preferably the separator body is circular or substantially circular. A gas separator for use with a planar fuel cell will generally be in the form of a plate, and a zirconia plate, for example, may be formed by tape casting the green material and sintering. Suitable manufacturing methods may be readily identified and do not form part of the present invention. The separator body may be formed in two or more layers, for example of zirconia, that may be separated by a layer of electrically conductive material in contact with the paths of electrically conductive material through the layers of the separator body, as described in the aforementioned WO 03/007403. Preferably the electrically conductive material in the paths and of such a separating layer is the same.

As noted already, the separator body must be gastight to the gases used in the fuel cell assembly, and most preferably the material of the separator body is dense. However, the material could be porous, with the electrically conductive material of the paths plugging the pores through the thickness of the material. Preferably, however, the paths of electrically conductive material are defined by perforations through the separator body, and for convenience they will be described in this way hereinafter.

The perforations preferably extend at least substantially perpendicularly through the thickness of the separator body. However, this is not essential and it may be advantageous for the paths of electrically conductive material to be inclined to the perpendicular. Each path at the anode side of the separator body may be offset relative to a connected path at the cathode side to further alleviate the risk of diffusion of oxygen through the paths of electrically conductive material.

Each perforation and/or path of electrically conductive material through the separator body preferably has a diameter or average cross-sectional dimension (excluding any head on the electrically conductive material) in the range of 50 to 1000 μm. The perforations may be formed during manufacture of the separator body or subsequently, for example by laser cutting. The minimum size of the perforations is a function of the difficulty of forming them and plugging them with the electrically conductive material. More preferably, the average cross-sectional dimension is in the range 200 to 500 μm, for example about 350 μm.

The minimum number of perforations is a function of their size, the electrical conductivity of the material in them and the electrical current to be transmitted by the gas separator. If the perforations have an average cross-sectional dimension towards the upper end of the preferred range, they may be fewer in number and more widely spaced. Preferably, the total area of the paths of electrically conductive material through the separator body (excluding any head on the electrically conductive material) is in the range of 0.1 mm² to 20 mm² per 1000 mm² surface area (measured on one side only) of the electrode contacting zone of the separator body, more preferably in the range 0.2 mm² to 5 mm² per 1000 mm². In a currently preferred embodiment, there are 19 paths of electrically conductive material having an average diameter (excluding any head on the electrically conductive material) of about 350 μm through a separator body having an electrode contacting zone or functional gas separating area of about 5400 mm². Preferably the paths of electrically conductive material through the separator body are at least substantially (within 10%) equally spaced from each other.

Advantageously, the paths of electrically conductive material may also provide thermally conductive paths for transmission of heat away from the fuel cells on opposite sides of the gas separator.

The electrically conductive material in the paths through the separator body may be metallic silver (commercially pure), a metallic mixture in which Ag is the major component, or a silver alloy. These may be in the form of sintered dense plugs.

Particularly if the fuel cell operating temperature will be higher than about 900° C., above the melting point of silver, for example up to 1100° C., the silver may be alloyed with any suitable ductile metal or metals having a sufficiently high melting point. Examples of such metals are one or more noble metals such as gold, palladium and platinum. Preferably, there will be no less than 50 wt % Ag present in the alloy. A cheaper material to combine with the Ag is stainless steel. Other alternatives are aluminium and tin. The Ag and other alloying or blending metal(s) may be mixed as powders and sintered together by firing in the perforations through the separator body. Preferably, the powders are commercially pure (≧99.9% purity), with a particle size in the range of 5 to 75 μm.

The metallic silver, silver mixture or silver alloy electrically conductive material may be introduced to the perforations by any suitable method, including screen or stencil printing a slurry of the metal, mixture or alloy in an organic binder into the perforations, or coating at least one surface of the separator body by, for example, printing, vapour deposition or plating and causing the coated metal, mixture or alloy to enter the perforations.

Most preferably, the electrically conductive material of the paths through the separator body is a silver-glass composite. This has the advantage of separating the desired level of electrical conductivity of the gas separator from the material of the separator body by the use of silver in the perforations, and alleviating the risk of leakage of gases through the separator body by the use of glass in the perforations. The glass may soften at the operating temperature of the fuel cell and, if necessary, can flow with expansion and contraction of the separator body as the separator is subjected to thermal cycling. The ductility of the silver facilitates this. The silver-glass composite may effectively be in the form of pure silver or a silver-based material in a glass matrix.

The silver-glass composite preferably comprises from about 10 to about 40 wt % glass, more preferably from 15 to 30 wt % glass. About 10 wt % glass is believed to be the lower limit to provide adequate sealing advantages in the separator, while at a level above about 40 wt % glass there may be insufficient silver in the composite to provide the desired level of electrical conductivity. Potentially, the proportions of silver and glass in the composite may be varied to best suit the CTE of the separator body but the major advantages of the composite lie in the ability of the material to deform with expansion and contraction of the separator and to conduct electricity.

The mixture of silver and glass in the silver-glass composite may be formed by a variety of suitable processes, including mixing glass and silver powders, mixing glass powder with silver salts, and mixing sol-gel glass precursors and silver powder or silver salts. Alternatively, for example, the silver or silver salt may be introduced to the glass matrix after the glass particles have been provided in the body of the gas separator, as described hereinafter. The material is then fired. One suitable silver salt is silver nitrate. In a preferred embodiment silver and glass powders are used, preferably with a particle size in the range of 5 to 75 μm. A suitable binder is for example an organic screen printing medium or ink. After mixing and application of the material, it is fired.

As described above, the silver in the composite may be commercially pure (>99.9% purity), a material mixture in which Ag is the major component or, for example, a silver alloy.

Silver may advantageously be used alone in the glass matrix provided the operating temperature of the fuel cell is not above about 900° C., for example in the range 800 to 900° C. There may be some ion exchange of the silver at the interface with the glass that may strengthen the Ag-glass bond and may spread interface stresses. Alternatively, one or more of the alloying metals indicated above may be combined with the silver prior to mixing into the glass matrix. If the high melting temperature alloying metal or metals excessively reduces the ability of the silver alloy to bond with the glass by ion exchange at the interface, a lower melting temperature metal such as copper may be also included.

A variety of different glass compositions can be used in the silver-glass composite. The glass composition should be stable against crystallisation (for example, less than 40% by volume crystallisation) at the temperatures and cool-down rates at which the fuel cell gas separator will be used. Advantageously, the glass composition has a small viscosity change over the intended fuel cell operating range of, for example, 700 to 1100° C., preferably 800 to 900° C. At the maximum intended operating temperature, the viscosity of the glass should not have decreased to the extent that the glass is capable of flowing out of the separator under its own weight.

Preferably, the glass is low in (for example, less than 10 wt %) or free of fuming components, for example no lead oxide, no cadmium oxide, no zinc oxide, and no or low sodium oxide and boron oxide. The type of glasses that exhibit a small viscosity change over at least the 100° C. temperature range at the preferred fuel cell operating range of 800° C. to 900° C. are typically high silica glasses, for example in the range 55 to 80 wt % SiO₂. Such glasses generally have a relatively low CTE.

Preferred and more preferred compositions of such a high silica glass, particularly for use with a zirconia gas separator body, are set out as Glass Type 1 in Table 1.

TABLE 1
Type 1-5 Glass compositions, in wt %

| | Glass Type | | | | | |
|---|---|---|---|---|---|---|
| | 1 | | | | | |
| | | More | | | | |
| | Preferred | Preferred | | | | |
| Oxide | Range | Range | 2 | 3 | 4 | 5 |
| Na₂O | 0-5.5 | 0-2.0 | 0-2 | 0-1 | 0-2 | 8-14 |
| K₂O | 8-14 | 8-13.5 | 0-2 | 0-1 | 0-2 | 2-8 |
| MgO | 0-2.2 | 0-0.1 | 0-1 | 0-2 | 0-2 | 0-2 |
| CaO | 1-3 | 1-1.6 | 35-40 | 15-18 | 10-12 | 0-1 |
| SrO | 0-6 | 0-0.1 | 0-1 | 0-1 | 0-1 | 0-1 |
| BaO | 0-8 | 0-4.4 | 0-1 | 30-40 | 25-35 | 0-1 |
| B₂O₃ | 6-20 | 6-20 | 0-2 | 0-1 | 24-28 | 0-0.5 |
| Al₂O₃ | 3-7 | 5-7 | 16-22 | 1-4 | 2-4 | 1-4 |
| SiO₂ | 58-76 | 60-75 | 38-48 | 40-45 | 25-30 | 65-75 |
| ZrO₂ | 0-10 | 0-5 | 0-1 | 0-1 | 0-1 | 12-18 |

The composite electrically conductive material may be introduced to the perforations by any suitable means. For example, after the glass powder or particles have been introduced to the perforations, a solution of a silver salt or very fine suspension of the silver material, for example as a liquid coating applied to one or both surfaces of the separator body, may be permitted or caused to be drawn through the glass particles in the perforations, such as by capillary action. Alternatively, the solution or suspension could be injected in. More preferably, a mixture of the glass and silver material powders in a binder is printed, for example by screen or stencil printing, onto one or both surfaces of the separator body to at least partly fill the perforations. The mixture is then heated to melt the glass and ultimately sinter the silver. The molten glass-silver composite flows in the perforations to seal them. A suitable heating/firing temperature is dependent upon the glass composition and the silver material but is preferably in the range 650 to 950° C. for pure silver in a high silica glass matrix for optimum melting of the glass without undue evaporation of the silver.

A disadvantage of using a material that is an ionic conductor, such as zirconia, for the separator body is that oxygen ions may migrate through the separator body from the cathode (oxidant) side to the anode (fuel) side. If oxygen ions are available on the anode side of the separator, a voltage can be established that is in reverse polarity to that of the fuel cell, thereby reducing the output power generated by the fuel cell assembly. To alleviate this, the anode side coating may comprise an ion barrier layer that extends in contact with the ionic conducting separator body over the entire electrode contacting zone except for an opening at each path of electrically conductive material. If the individual silver-barrier patches directly overlie the respective paths of electrically conductive material, in accordance with embodiments of the first aspect of the invention, the ion barrier layer may partially overlie the silver-barrier patches. This may help to hold down the edges of the individual silver-barrier patches and alleviate the risk of gas leaking from the paths of electrically conductive material via the silver-barrier patches to the anode side of the separator body.

Since the primary purpose of the ion barrier layer is to prevent oxygen ions that migrate through the material of the separator body escaping to the anode side of the separator, the ion barrier layer is not required to be overly thick. Preferably the thickness is in the range of 5 to 30 μm, more preferably 10 to 20 μm.

Suitable materials for the ion barrier layer include titania, alumina and glass. The glass should be of a crystalline type, and may be a compound of two crystalline glasses at a suitable ratio that the CTEs of the ion barrier layer and the separator body are substantially the same. Suitable crystalline glass compositions include those set out as Glass Types 2 and 3 in Table 1.

When the aforementioned electrically conductive underlayer is provided on the anode side of the gas separator body in accordance with the second aspect of the invention and the material has low catalytic activity for the fuel, such that there is no oxygen ion conduction through the separator body even when it is formed of an ionic conductor, the ion barrier layer may be unnecessary. This would be the case if, for example, the electrically conductive underlayer were formed of silver or a silver compound.

On the cathode side, one or more of the paths of electrically conductive material through the separator body, preferably all of them, may have an enlarged head to reduce the electrical resistance between the portion of the path of electrically conductive material through the separator body and the adjacent cathode side structure. The enlarged head may be up to 100 times the cross-sectional area of the adjacent portion of the path through the separator body and have a thickness of 50 to 200 μm, more preferably 100 to 150 μm. In one embodiment, the perforations through the separator body have a diameter of 0.35 mm and the head on the cathode side of each path of electrically conductive material has a diameter of about 2.5 to 3 mm. Most advantageously, the head on the cathode side is formed of the same material as the adjacent portion of the path of electrically conductive material through the separator body and is integral with it.

As with the optional enlarged head of each path of electrically conductive material on the anode side, reference herein to the paths of electrically conductive material through the separator body shall generally be understood to include reference to the preferred enlarged head on the cathode side.

The cathode side current collector layer is required to conduct electrical current laterally across the surface of the separator plate, connecting the paths of electrically conductive material to the adjacent cathode side structure, and to provide lateral heat transfer across the surface of the gas separator, thereby minimising stress induced in the gas separator due to temperature variation. Advantageously, it also provides for portions of the adjacent fuel cell cathode structure of varying height to embed into the layer so as to permit the cathode to contact the layer without applying varying mechanical stresses. The cathode side current collector layer preferably has a thickness in the range of 50 to 180 μm, more preferably 80 to 150 μm.

Materials that can perform the above functions of the cathode side current collector layer under the operating conditions of a solid oxide fuel cell include silver, gold, platinum and palladium, either on their own or as an alloy of two or more of them. The currently preferred material is silver, formed by sintering silver powder of >99.9% purity and with a particle size in the range of 5 to 75 μm. The resulting structure after sintering should not be fully dense, in order to ensure that a desired degree of compliance is provided, and a pore former, preferably PBMA, is mixed with the silver powder and burns off when the silver is sintered, leaving the desired porous silver structure. The pore former may be provided in amounts of 10 to 30 wt %, preferably 15 to 20 wt %, of the silver. Alternatively, the cathode side current collector layer may be made from a foil of the selected material, provided less compliance is required in it for the adjacent cathode components. Preferably the porosity of the cathode side current collector layer is in the range of 10-50 vol %.

The cathode side current collector layer may extend over the entire electrode contacting zone on the cathode side of the separator body. Alternatively, the cathode side current collector layer may have a respective opening at each path of electrically conductive material through the separator body, with the layer either extending to immediately adjacent and contacting the adjacent portion of the path or partially overlying the adjacent portion of the path. A respective sealing patch may be provided over and in intimate sealing contact with at least one, preferably each, path of electrically conductive material on the cathode side, to alleviate diffusion of oxygen through the at least one path of electrically conductive material. In a variation described below, if the sealing patch material is electrically conductive, it may not be necessary for the cathode side current collector layer to contact or overlie the at least one path of electrically conductive material.

Each such sealing patch may have a thickness up to 150 μm, depending on the material from which it is formed and its ability to block access for oxygen on the cathode side to the paths of electrically conductive material in the separator body.

One material for the sealing patch is glass, preferably a viscous glass such as Glass Type 1, 4 or 5 in Table 1. A glass sealing patch may have a thickness of, for example, 75 to 150 μM, preferably 100 to 140 p.m. Such a sealing patch material would be non-electrically conductive, so the cathode side current collector layer would still need to contact the paths of electrically conductive material, for example around the edges of the sealing patch. In this arrangement each sealing patch may be provided in one of the aforementioned openings in the cathode side current collector layer, or the current collector layer may extend as a continuous layer over the sealing patch.

In another embodiment, the sealing patch material is electrically conductive, in which case it may not be essential for the cathode side current collector layer to be in direct electrical contact with the paths of electrically conductive material and each sealing patch may extend beyond the respective path of electrically conductive material and bond to the separator body around the path. Such an overlap with the path of electrically conductive material may be, for example, in the range of 0.3 to 1 mm. The sealing patch material in this embodiment may be provided in one of the aforementioned openings in the cathode side current collector layer, or the current collector layer may extend as a continuous layer over the sealing patch.

In this embodiment, the sealing patch material may be a glass composite with suitable metal, preferably one or more of the noble metals platinum, gold, palladium and rhodium. Any of the glass Types 1, 4 and 5 in Table 1 would be suitable for this glass composite. The composite may be formed in the same manner described herein for the electrically conductive nickel/glass silver-barrier batch, except that the nickel is replaced by one or more of platinum, gold, palladium and rhodium.

Alternatively in this embodiment, the sealing patch is a very thin coating, preferably about 1 μm thick, applied to the cathode side enlarged head of each path of electrically conductive material. Suitable materials for such a coating include tin and rhodium.

In another embodiment, the risk of oxygen diffusing through the paths of electrically conductive material from the cathode side of the gas separator is alleviated by the cathode side coating comprising an oxygen barrier layer between the separator body and the cathode side current collector layer. The features of the cathode side oxygen barrier layer may be selected from those described above for the anode side gas barrier layer of the gas separator of the second aspect of the invention. In particular, it is preferred that the cathode side oxygen barrier layer is formed of glass, most preferably two layers of glass, respectively of viscous glass and crystalline glass, with passages of relatively conductive material therethrough that are all offset relative to the paths of electrically conductive material through the separator body. Offsetting the passages of relatively conductive material through the oxygen barrier layer relative to the paths of electrically conductive material through the separator body increases the length of potential oxygen diffusion paths.

To facilitate electrical conductivity between the paths of electrically conductive material through the separator body and the passages of electrically conductive material through the cathode side oxygen barrier layer, the cathode side coating preferably comprises an electrically conductive underlayer between the separator body and the oxygen barrier layer. The cathode side electrically conductive underlayer should extend over the entire electrode contacting zone of the separator body on the cathode side, and may also provide lateral heat transfer across the surface of the separator body to alleviate stress imparted in the separator body due to temperature variations. Preferably, the cathode side electrically conductive underlayer has a thickness in the range of 20 to 100 μm, more preferably 40 to 80 μm.

The material of the cathode side electrically conductive underlayer may be selected from gold, platinum, palladium and silver, either on their own or as an alloy of two or more of them or of one or more of them with a suitably compatible material. A currently preferred material is silver sintered from a powder of >99.9% purity with a particle size in the range of 5 to 75 μm. Alternatively, a silver/glass composite may be used, similar to that described above with reference to the electrically conductive material of the paths through the separator body. The glass may be viscous and selected from any of Glass Types 1, 4 and 5 in Table 1. Such a silver/glass composite cathode side underlayer may at least in part replace any enlarged head of the paths of electrically conductive material on the cathode side.

The relatively electrically conductive material in the passages through the cathode side oxygen barrier layer is preferably the material of either the cathode side electrically conductive underlayer or the cathode side current collector layer, or both.

Three means are described herein for alleviating the problem of oxygen diffusing through the silver of the paths of electrically conductive material through the separator body, from the cathode side to the anode side and reacting with hydrogen on the anode side; namely 1) providing a gas barrier layer on the anode side between the separator body and the anode side current collector layer, with openings through the gas barrier layer containing relatively conductive material being offset from the paths of electrically conductive material to increase the oxygen diffusion path length, 2) providing an oxygen barrier layer on the cathode side between the separator body and the cathode side current collector layer, with openings through the oxygen barrier layer containing relatively conductive material being offset from the paths of electrically conductive material to increase the oxygen diffusion path length, and 3) providing a respective sealing patch over and in intimate sealing contact with at least one path of electrically conductive material on the cathode side.

Each of these three means may be used separately or two or more of them may be used together. However, each has been described hereinbefore as used in a gas separator in accordance with one or both of the first and second aspects of the invention, that is a gas separator incorporating respective silver-barrier patches for preventing the diffusion of Ag therethrough to the anode side of the gas separator. It will be appreciated that any one or more of the three described means for alleviating the problem of oxygen diffusing through the silver of the paths of electrically conductive material may be used in a gas separator for use between two solid oxide fuel cells that is not in accordance with the first or second aspects of the invention.

Accordingly there is provided according to a third aspect of the invention a fuel cell gas separator for use between two solid oxide fuel cells, the gas separator having a separator body with an anode side and a cathode side and with paths of electrically conductive material therethrough from the anode side to the cathode side in an electrode contacting zone of the separator, the electrically conductive material being Ag or a silver-containing material, an anode side coating over the electrode contacting zone comprising a current collector layer and a cathode side coating over the electrode contacting zone comprising a current collector layer, and one or both of 1) an oxygen gas barrier layer on one or each of the anode side and the cathode side between the separator body and the respective current collector layer, and 2) a respective sealing patch over and in intimate sealing contact with each path of electrically conductive material on the cathode side.

The gas barrier layer(s) and/or the sealing patch of the gas separator in accordance with the third aspect of the invention may take any of the features of those components described with reference to the first and/or second aspects of the invention. Furthermore, the gas separator in accordance with the third aspect of the invention may include any one or more of the optional features of the gas separators described with reference to the first and/or second aspects of the invention, and the description of the first and second aspects of the invention shall be construed accordingly.

### BRIEF DESCRIPTION OF THE DRAWINGS

Various embodiments of a solid oxide fuel cell gas separator in accordance with the present invention will now be described by way of example only with reference to the accompanying drawings in which:

FIG. 1 is an exploded perspective view of a generic solid oxide fuel cell gas separator plate and associated solid oxide fuel cell plate;

FIG. 2 is a plan view from above of the generic gas separator plate of FIG. 1;

FIG. 3 is a partial cross-sectional view of one embodiment in accordance with the invention of the gas separator plate of FIGS. 1 and 2, taken on the line A-A of FIG. 2, sandwiched between two fuel cell plates also shown in partial cross-section;

FIG. 4 is a schematic unscaled enlargement of part of the gas separator plate of FIG. 3;

FIG. 5 is a partial cross-sectional view of a second embodiment in accordance with the invention of the gas separator plate of FIGS. 1 and 2, taken on the line A-A of FIG. 2;

FIG. 6 is a schematic unscaled enlargement of part of the gas separator plate of FIG. 5 showing modifications thereto;

FIG. 7 is an unscaled cross-sectional view schematically illustrating a variation of the gas separator plate of FIG. 6;

FIG. 8 is a view similar to the partial cross-section of the gas separator plate of FIG. 3, but showing a modification on the cathode side;

FIG. 9 is an unscaled schematic enlargement of part of the gas separator plate of FIG. 8, but showing a variation on the cathode side; and

FIG. 10 is a view similar to FIG. 4, but showing a modification on the anode side of the gas separator plate.

### DETAILED DESCRIPTION OF EMBODIMENTS OF THE INVENTION

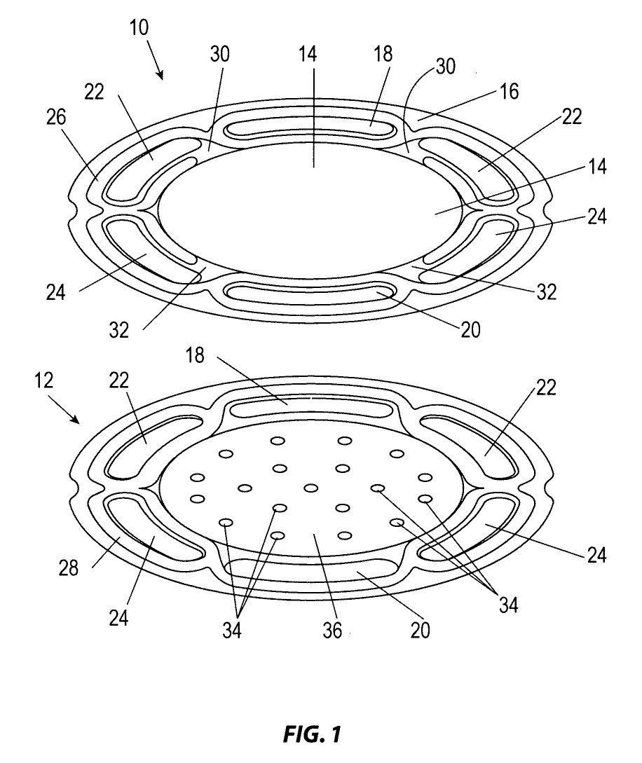

Referring to FIG. 1, there is shown (in exploded manner) a solid oxide fuel cell plate 10 superposed over a gas separator plate 12. In use, the plates 10 and 12 are in at least substantially face to face contact and there would be a stack of alternating fuel cell plates 10 and gas separator plates 12 forming a solid oxide fuel cell assembly.

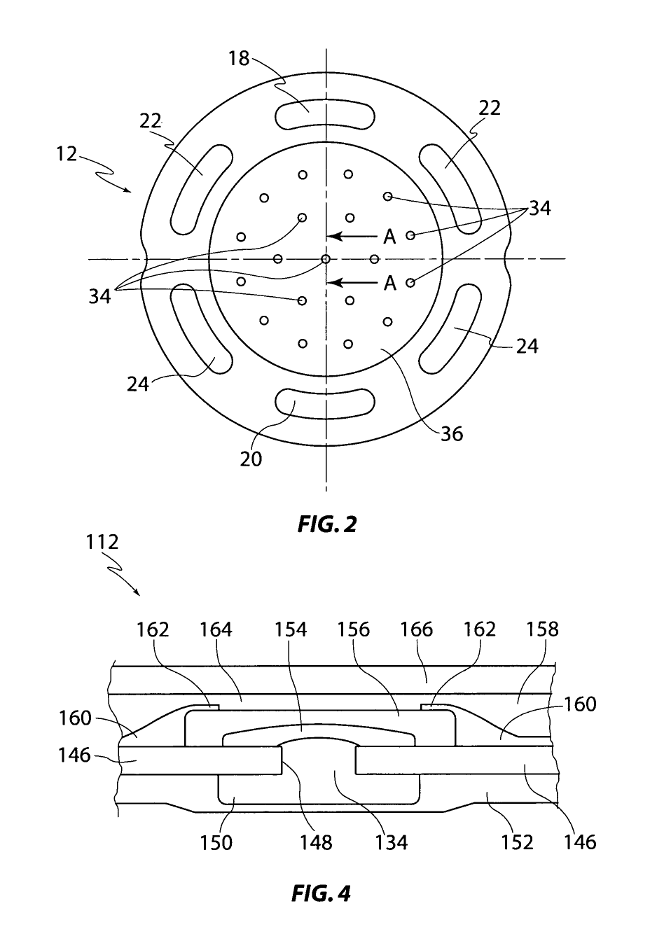

The plates 10 and 12 are seen in perspective view from above with a cathode layer 14 visible on an electrolyte layer 16 on the fuel cell plate 10. The electrolyte layer 16 extends across the full diameter of the fuel cell plate 10, whereas the cathode layer 14 extends across only a central portion of the plate. An anode layer (not visible) corresponding to the cathode layer 14 is provided on the underside (in the drawing) of the fuel cell plate. The gas separator plate 12 is also shown in plan view in FIG. 2.

The fuel cell and gas separator plates 10 and 12 are generally circular and are internally manifolded with a fuel inlet opening 18, an opposed fuel outlet opening 20, air inlet openings 22 on opposite sides of the final inlet opening and respectively opposed air outlet openings 24, which respectively align when the plates are stacked to form the manifolds. In the fuel cell plate 10 these openings are formed through the electrolyte layer 16 outwardly of the central portion on which the cathode layer 14 and anode layer are disposed. A gasket-type seal 26 and 28, respectively, is provided on the upper face (in the drawing) of each of the fuel cell and gas separator plates 10 and 12. The gasket-type seals 26 and 28 are conveniently formed of a glass composition or a glass composite.

The seal 26 has air inlet ports 30 associated with the air inlet openings 22 and air outlet ports 32 associated with the air outlet openings 24 to permit air to flow across the cathode layer 14 between the cathode and the adjacent gas separator plates (not shown). The seal 26 extends wholly around the fuel inlet opening 18 and outlet opening 20 to prevent fuel flowing over the cathode side of the fuel cell plate 10.

Correspondingly, the seal 28 on the gas separator plate 12 extends wholly around the air inlet openings 22 and the air outlet openings 24, but only around the exterior of the fuel inlet opening 18 and the fuel outlet opening 20 so as to define ports through which fuel gas can flow from the fuel inlet opening 18, across the anode, between the fuel cell plate 10 and adjacent gas separator plate 12, before exiting through the fuel outlet opening 20.

Means (not shown in FIGS. 1 and 2) is provided to distribute the reactant gas across the respective electrode and to provide at least a degree of support for all of the plates 10 and 12 in a fuel cell stack. Such means may be in the form of electrically conductive surface formations on the gas separator plate 12, or on the fuel cell plate 10. Alternatively, the gas may be distributed by a separate member (not shown) between the plates 10 and 12, such as a mesh or corrugated structure, that may also act as a current collector. Preferably the distribution means is in the form of short pillars on the anode and cathode layers, as described with reference to FIG. 3.

The material of the cathode layer 14 of the fuel cell plate 10 is preferably a conductive perovskite such as lanthanum strontium manganate that is porous, and the anode layer is preferably formed of a porous nickel-zirconia cermet.

The electrolyte layer 16 of the fuel cell plate 10 is a fully dense yttria-stabilised zirconia such as 3Y, 8Y, or 10Y strengthened with 2-15 wt % alumina and extends beyond the electrode layers to define the internally manifolded fuel and air inlet and outlet openings therethrough, to support the seal 26 and to provide a contact surface for the seal 28 on the gas separator plate 12.

The gas separator plate 12 has a similar profile to the fuel cell plate 10 and is also formed of a fully dense zirconia to at least substantially match the CTE of the electrolyte layer 16 of the fuel cell. In the preferred embodiment, the zirconia body of the plate 12 has a thickness of 150 μm. The zirconia of the gas separator plate 12 is also yttria-stabilised and strengthened with up to 20 wt % alumina. The currently preferred material is zirconia stabilised with 10% yttria and strengthened with 2-15% alumina for both the gas separator plate 12 and the electrolyte layer 16.

Since the zirconia is not electrically conductive and one of the functions of the gas separator plate 12 is to transmit electrical current from one fuel cell to the next through the stack, electrically conductive feedthroughs 34 (shown schematically in FIGS. 1 and 2) are provided through the thickness of a planar central portion or electrode contacting zone 36 of the gas separator plate corresponding in shape and size to the adjacent electrode on the central portion of the electrolyte layer 16 of the fuel cell plate 10 and having a diameter of about 80 mm. The feedthroughs 34 comprise a silver or silver containing material in substantially perpendicular perforations through the plate 12. Each feedthrough 34 has a respective enlarged head on each of the cathode and anode sides, as represented schematically in FIG. 2. Although the feedthroughs 34 through the gas separator plate 12 are illustrated as visible, in accordance with the invention they would be covered with one or more layers across the electrode contacting zone 36 on each side, as described with reference to the embodiments below. FIGS. 1 and 2 therefore illustrate the gas separator plate 12 generically.

As illustrated, there are nineteen feedthroughs 34 in the electrode contacting zone 36 of the gas separator plate 12, arranged with one in the centre of the electrode contacting zone and two arrays of six and twelve in respective concentric circles around the centre such that the feedthroughs are approximately equally spaced. In a preferred embodiment, the perforations through the plate 12 in which the feedthroughs 34 are provided have a diameter of 0.35 mm and the feedthrough material is a composite of 80 wt % silver in glass to achieve a balance between electrical conductivity and gas tightness. The silver is commercially pure and the glass has a composition in accordance with the more preferred range of Glass Type 1 in Table 1.

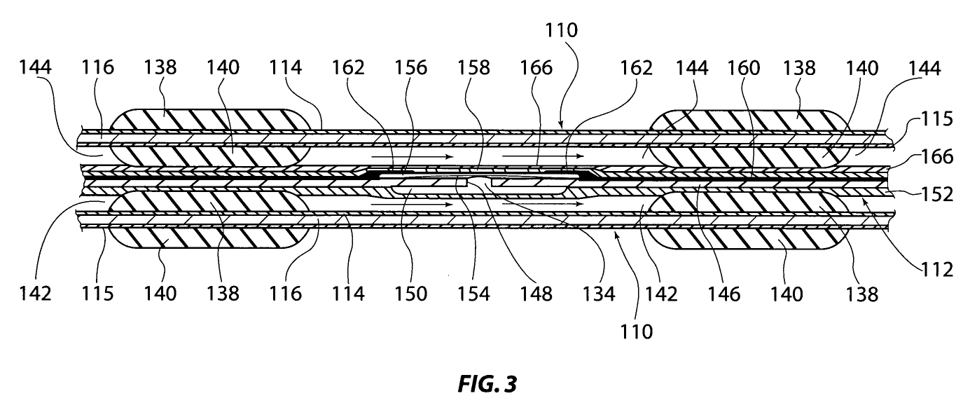

The feedthroughs are formed from a precursor mixture prepared by mechanical agitation of powdered glass having a particle size of less than 100 μm and an average size range of 13 to 16 μm and commercially pure silver metal powder having a particle size range of less than 45 μm in binder. A suitable binder system is a combination of screen printing inks available under the brand names Cerdec and Duramax. The precursor mixture is screen printed onto one or both surfaces of the separator body to at least partly fill the perforations. The mixture is then heated to melt the glass and ultimately sinter the silver. The molten glass-silver composite flows in the perforations to seal them. A suitable heating/firing temperature for pure silver in a high silica glass matrix is up to 950° C. for optimum melting of the glass without undue evaporation of the silver. As noted above, the feedthroughs 34 have enlarged heads on the anode and cathode sides, and these will be described in greater detail with reference to FIGS. 3 and 4.

Referring to FIG. 3, part of a gas separator plate 112 in accordance with the invention and having feedthroughs 134 is shown sandwiched between upper and lower fuel cell plates 110. In a fuel cell stack, this pattern would be repeated many times.

Each fuel cell plate comprises an electrolyte layer 116, a cathode layer 114 and an anode layer 115, each as described with reference to FIG. 1. Each fuel cell plate 110 has a regularly spaced array of short electrically conductive pillars 138 on the cathode side and a corresponding opposite array of short electrically conductive pillars 140 on the anode side. The cathode side pillars 138 are formed of a perovskite material similar to the cathode material and the anode side pillars 140 are formed of a nickel/zirconia cermet similar to the anode material. The pillars are disposed on the respective electrode materials by stencil printing. They have a nominal height in the range of about 200 to 500 μm and abut the gas separator plate 112 to form oxidant gas flow passages 142 around the pillars 138 between the lower fuel cell plate 110 and the gas separator plate 112 and fuel gas passages 144 around the pillars 140 between the gas separator plate and the upper fuel cell plate 110, respectively. As shown, the short pillars may have a diameter of about 3 mm, but it will be appreciated that the pillars themselves do not form any part of the present invention.

Referring to FIGS. 3 and 4, it may be seen that the zirconia separator body 146 of the gas separator plate 112 has a respective perforation 148 therethrough in which each feedthrough 134 is provided. Each feedthrough 134 completely fills the respective perforation 148 to seal it and has an integral enlarged head 150 on the cathode side of the same material. In one embodiment, the integral head 150 has a thickness of about 120 μm and a diameter of about 3 mm. The enlarged head 150 adheres to the cathode side of the gas separator body 146 around the perforation 148 and helps to seal the perforation 148 against the flow of gas therethrough and to reduce the electrical resistance of the junction between the feedthrough 134 and the cathode side current collector layer 152.

The cathode side current collector layer 152 extends over the whole of the electrode contacting zone 36 on the cathode side and is formed of porous silver to conduct electrical current laterally across the surface of the separator plate on the cathode side, connecting the feedthroughs 134 to the pillars 138 on the adjacent fuel cell plate 110 as well as to provide lateral heat transfer across the surface of the separator plate in order to minimise stress induced in the separator plate due to temperature variation.

In one embodiment the cathode side current collector layer 152 has a regular thickness of about 120 μm, which combined with the porosity of the layer give it a degree of compliance allowing the pillars 138 to embed into the layer so that the pillars can contact the layer without applying mechanical stress to the separator body 146 even if they are of slightly different heights. However, the cathode side current collector layer 152 bulges slightly over the enlarged head 150, where it is of reduced thickness.

Preferably the layer 152 is formed from a commercially pure silver powder having a particle size range of 5 to 75 μm mixed with 15 to 20 wt % PBMA as a binder and pore former that burns off during sintering of the powder so that the resultant layer has a porosity in the range of 10-50 vol %.

On the anode side, the enlarged head 154 is adhered to the anode side of the separator body 146 around the perforation 148 and is provided to reduce electrical resistance between the feedthrough 134 and the overlying anode side coating of the gas separator 112. However, it is formed of commercially pure silver and is therefore not integral with the portion of the feedthrough 134 in the perforation 148. In a preferred embodiment, the enlarged head 154 is about 40 μm thick and about 2 mm in diameter. Its size can be reduced compared to that of the cathode side enlarged head 150 because of its enhanced electrical conductivity compared to that of the head 150.

A disadvantage of using silver in or for the anode side enlarged head 154 of the feedthrough 134 is that it can evaporate and become very mobile at the operating temperature of a solid oxide fuel cell and that the internal reforming function of the anode 115 of the adjacent fuel cell 110 is poisoned by silver contacting it. To alleviate this, an individual silver-barrier patch 156 directly overlies the anode side enlarged head 154 of the feedthrough and is sealed to the anode side of the separator body 146 around the enlarged head to alleviate the leakage of silver from the feedthrough (including its enlarged heads) to the anode side of the separator plate 112. The silver-barrier patch 156 may also alleviate the leakage of oxygen to the anode side if the oxygen diffuses through the feedthrough 134 at the elevated fuel cell operating temperature.

The silver-barrier patch 156 needs to be electrically conductive in order to conduct electrical current from the feedthrough 134 to the anode side current collector layer 158. A preferred material to perform all the functions of the silver-barrier patch 156 is a nickel/glass compound formed from sintered mixed powders in a ratio of 10 to 30 wt % nickel to achieve a suitable balance between electrical conductivity and silver blocking. The nickel powder is commercially pure with a particle size in the range of 5 to 75 μm. The glass powder is a viscous type with a composition that may be selected from any of Glass Type 1, 4 and 5 in Table 1 and a particle size also in the range 5 to 75 μm. Each silver-barrier patch has a thickness of about 100 μm and a diameter of about 3 mm.

An ion barrier layer 160 is disposed between the gas separator body 146 on the anode side and the current collector layer 158. It extends over the whole of the electrode contacting zone 36 beneath the current collector layer 158, except at the feedthroughs 134 where it overlaps the silver-barrier patch 156 at 162, to define an opening 164 of about the same diameter as the enlarged head 154 on the anode side of the feedthrough 134.

The ion barrier layer 160 is formed from a compound of two crystalline glasses at a ratio to give the layer a co-efficient of thermal expansion the same as that of the separator plate. The preferred crystalline glass compositions are as set out for Glass Types 2 and 3 in Table 1. The crystalline glass gives greater stability against reacting with the adjacent gas separator layers than would viscous glass.

The function of the ion barrier layer is to prevent the migration of oxygen ions from the cathode side of the separator body 146 to the anode side, given that the zirconia of the separator body is ionically conductive. The overlapping portion 162 of the ion barrier layer at each feedthrough may also assist in sealing the edges of the silver-barrier layer to minimise the leakage of material from the feedthrough enlarged head 154 between the separator body and the patch 156.

The anode side current collector layer 158 extends over the entire electrode contacting zone 36 and is provided to conduct electrical current laterally across the surface of the separator plate 112, connecting the feedthroughs 134 and overlying silver-barrier patches 156 to the electrically conductive anode side pillars 140 on the adjacent fuel cell 110. The layer 158 also provides lateral heat transfer across the surface of the separator plate, to minimise stress induced in the separator plate due to temperature variation.

The anode side current collector layer 158 is formed from sintered nickel powder that is commercially pure and has a particle size in the range of 5 to 75 μm. It has a regular thickness of about 50 μm, but this is reduced at each feedthrough 134.

Overlying the entire anode side current collector layer 158 is an anode side compliant layer 166 which provides the ability for the anode side pillars 140 to embed into the layer without applying mechanical stress to the gas separator plate 112. Generally, the pillars 140 will not embed sufficiently far into the compliant layer 166 as to contact the current collector layer 158, so the compliant layer must also conduct electrical current between the layer 158 and the pillars 140 on the adjacent fuel cell 110.

The compliant layer 166 has a thickness of about 150 μm and is formed from sintered nickel powder. The nickel powder is commercially pure and has a particle size in the range of 5 to 75 μm. It is blended with 15 to 20 wt % PBMA, which acts as a pore former that burns away when the mixture is fired to leave a porous nickel structure that is readily indented.

In the following description of variations to the gas separator described with reference to FIGS. 3 and 4, similar parts will be given a corresponding reference numeral separated by 100, or in some cases distinguished by a prime “′”. These parts will generally have a similar function and structure, so for convenience they will only be described in detail insofar as they are different from the corresponding parts of the embodiment of FIGS. 3 and 4.

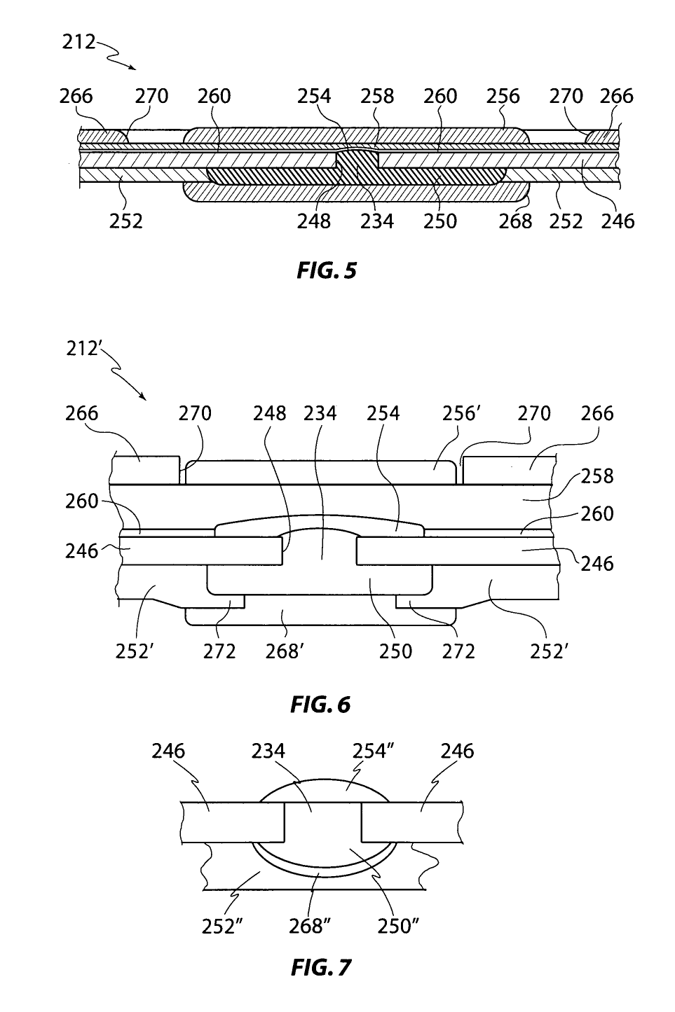

Referring to FIG. 5, a gas separator plate 212 has a zirconia separator body 246 with perforations 248 therethrough sealed by respective feedthroughs 234. Each feedthrough has an integral enlarged head 250 on the cathode side and a non-integral silver enlarged head 254 on the anode side.

On the cathode side, the current collector layer 252 differs from the cathode side current collector layer 152 in that it does not overlie the enlarged head 250 of the feedthrough 234, but extends up to and abuts the enlarged head instead. A glass sealing patch 268 overlies and is sealed to the enlarged head 250 on the cathode side. It has a thickness of about 120 μm and a diameter of about 3 mm, so also overlaps the cathode side current collector layer 252. The sealing patch 268 improves the gas-tight sealing ability of the feedthrough 234 by reducing access for oxygen on the cathode side to the silver in the feedthrough. Preferably the glass of the sealing patch is viscous and has a composition such as that given for Glass Types 1 and 4 in Table 1.

On the anode side, the silver-barrier patch 256 does not directly overlie the enlarged head 254 of the feedthrough 234. Thus, it is not in direct contact with the enlarged head 254. Instead, the ion barrier layer 260 extends up to and abuts the enlarged head 254 (as shown perhaps more clearly in FIG. 6), and the anode side current collector layer 258 directly overlies the enlarged head 254 at the feedthrough and the ion barrier layer 260 elsewhere.

The silver-barrier patch 256 overlies the enlarged head 254 of the feedthrough, in that it is aligned with the enlarged head, but is supported on the current collector layer 258 in a hole 270 through the anode side compliant layer 266. The silver-barrier patch has a diameter of 3 mm, whereas the hole 270 has a diameter of 4 mm. Thus there is a clearance between the silver-barrier patch 256 and the compliant layer 266 wholly around the silver-barrier patch. The silver-barrier patch 256 may have the same thickness of about 100 μm as the silver-barrier patch 156, or it may be greater provided it does not contact the adjacent fuel cell in use. As shown, the thickness of the silver-barrier patch 256 is about 200 μm.

A slightly thinner silver-barrier patch 256′ is shown in FIG. 6, but otherwise the anode side of the gas separator 212′ is identical to that of the gas separator 212 in FIG. 5. Likewise, the cathode side of the gas separator plate 212′ in FIG. 6 is the same as that of the gas separator plate 212, except that the cathode side current collector layer 252′ overlaps the enlarged head at 272 and the sealing patch 268′ overlies the annular overlapping portion 272 as well as the adjacent portion of the current collector layer 252′ and the enlarged head 250 so as to enhance sealing on the cathode side. The sealing patch 268′ therefore has a T-shaped section (inverted in FIG. 6), with the leg of the T within the annular overlapping portion 272 having a diameter of about 2 mm.

FIG. 7 illustrates another variation of FIG. 5, in which the only change on the anode side is that the enlarged head 254″ of the feedthrough 234 is rounded. On the cathode side, however, the integral enlarged head 250″ of the feedthrough is also rounded and the sealing patch 268″ directly overlies it and is sealed to the cathode side of the separator body 246 around the periphery of the enlarged head. Since this prevents the cathode side current collector layer 252″ from directly contacting the feedthrough 234, the material of the sealing patch 268″ must be conductive. A preferred material is a platinum/glass composite, with the platinum present in a proportion of 50 to 90 wt %. The glass is a viscous-type, with a similar composition to that described above for the silver/glass composite of the feedthroughs. The electrically conductive sealing patch 268″ may also be formed in a similar way to the metal/glass composites previously described herein. The platinum/glass sealing patch 268″ preferably has a thickness in the range of 60 to 120 μm sufficient to provide a barrier to the diffusion of oxygen from the cathode side through the silver in the feedthrough 234. The cathode side current collector layer 252″ extends wholly over the enlarged head 250″ of the feedthrough and the sealing patch 268″.

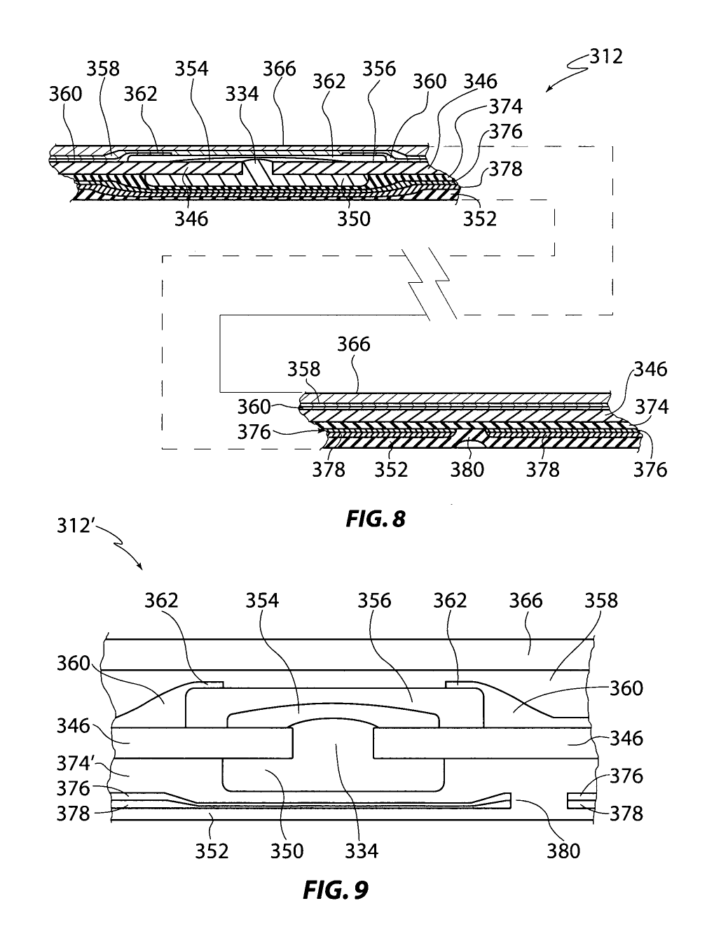

Referring now to FIG. 8, the gas separator body 346, the feedthrough 334 and the anode side of the gas separator plate 312 are respectively identical to the gas separator body 146, the feedthrough 134 and the anode side of the gas separator plate 112 described with reference to FIGS. 3 and 4. Thus, on the anode side, the enlarged head 354, the silver-barrier patch 356, the current collector layer 358, the ion barrier layer 360 with its overlap 362 and the compliant layer 366 are identical to the corresponding parts 154, 156, 158, 160, 162 and 166 of FIGS. 3 and 4, and will not be described further.

On the cathode side of the gas separator plate 312, the integral enlarged head 350 of the feedthrough 334 is also identical to the corresponding part 150 of the gas separator plate 112 of FIGS. 3 and 4. However, the cathode side current collector layer 352 is spaced from the gas separator body 346 and the enlarged head 350 by a current collector underlayer 374 and a gas barrier layer comprising two glass layers 376 and 378.

The gas barrier layer is designed to minimise the likelihood of oxygen on the cathode side reaching the feedthrough 334 and then diffusing through the silver of the feedthrough to the anode side.

The glass layer 376 closest to the current collector underlayer 374 may have a thickness of about 40 μm and be formed of viscous glass having a composition such as that described for Glass Types 1 or 4 in Table 1 to provide the primary gas barrier properties. The adjacent glass layer 378 of the gas barrier layer may have a thickness of about 60 μm and be formed of crystalline glass with a composition such as that described for Glass Types 2 or 3 in Table 1. The crystalline layer may provide a skin of the gas barrier layer to alleviate interaction between the viscous layer 376 and the current collector layer 352.

The glasses of the gas barrier layer are electrically insulating, and the gas barrier layer has a number of passages 380 therethrough that are all offset relative to the feedthroughs 334. In one embodiment, there are 18 passages 380 each having a diameter of about 3.5 mm (not shown to scale in FIG. 8) and each offset by about 8 mm from a respective feedthrough in one of the concentric circles of feedthroughs described with reference to FIGS. 1 and 2. Thus, each of the passages 380 may be approximately equally spaced between two feedthroughs 334 in the respective concentric circle. Other arrangements are clearly possible, with the intent that there are adequate paths of electrical current flow between all the feedthroughs 334 and the cathode side current collector layer 352 yet minimal oxygen transmission along those same paths.

The gas barrier layer extends over the whole of the electrode contacting zone 36, except for the passages 380, as does the current collector underlayer 374 which is provided to transmit electricity and heat laterally between the feedthroughs 334 and the passages 380. The underlayer 374 has a thickness of about 70 μm but, like the gas barrier layer, this is thinned over the bulge of the enlarged head 350 of the feedthrough 334. The preferred material is a silver/glass composite similar to that used for the feedthrough 334 and enlarged head 350, which is formed in a similar manner to the feedthrough. Even though both the underlayer 374 and the feedthrough 334 are formed of a silver/glass composite, it has been found that the enlarged head 350 of the feedthrough is necessary to ensure good electrical connectivity between the underlayer and the feedthrough. Possibly the enlarged head 350 could be omitted if the feedthrough and underlayer were fired at the same time.

The passages 380 are filled with the material of the cathode side current collector layer 352 to provide a conduction path between the underlayer 374 and the cathode side current collector layer 352. The regular thickness of the cathode side current layer 352 is about 120 μm and the layer extends over the whole of the electrode contacting zone 36. It is formed of silver, and its structure and formation are as described with reference to the cathode side current collector layer 152 of the gas separator plate 112 of FIGS. 3 and 4.

In the fuel cell plate 312′ of FIG. 9, the only difference from the fuel cell plate 312 of FIG. 8 is the material of the current collector underlayer 374′ on the cathode side. This is commercially pure silver alone, sintered from a powder having a particle size in the range of 5 to 75 μm. The structure and the formation of the underlayer 374′ may be identical to those of the cathode side current collector layer 352, except preferably that it is less porous. The cathode side gas barrier properties of this embodiment may not be as good as for the gas separator plate 312, but may be adequate given the offset between the feedthroughs 334 and passages 380 through the gas barrier layer as well as the provision of the silver-barrier patch 356.

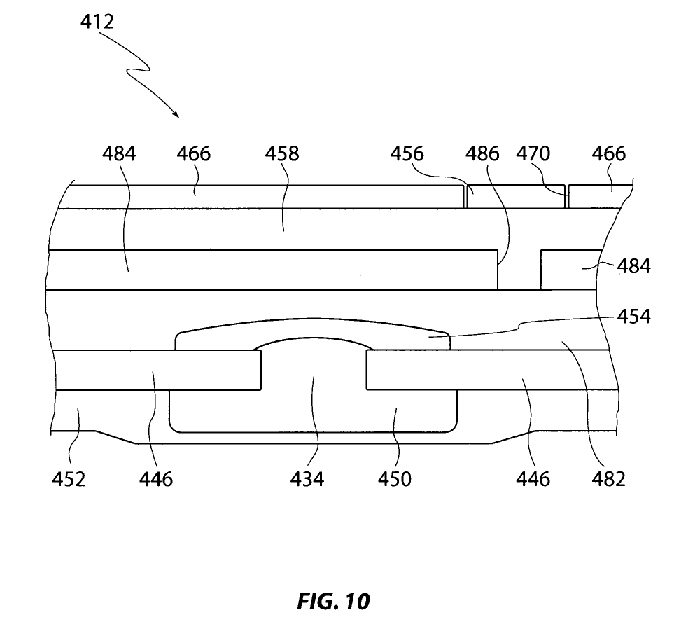

In the gas separator plate 412 of FIG. 10, the separator body 446 and feedthroughs 434 with their enlarged heads 450 are identical to the separator body 146 and feedthroughs 134 of the gas separator plate 112 of FIGS. 3 and 4. Likewise, the cathode side current collector layer 452 and, on the anode side, the enlarged head 454 is identical to the corresponding components 152 and 154 in the gas separator plate 112 of FIGS. 3 and 4.

Where the gas separator plate 412 differs principally from previous embodiments is in the provision of a gas barrier layer 484 on the anode side. The gas barrier layer 484 extends over the whole of the electrode contacting zone 36 to provide a substantially gas tight barrier between the feedthroughs 434 and the anode side current collector layer 458. The gas barrier layer 484 is formed of glass and, although not shown, is preferably formed of two glass layers identical to the glass layers 376 and 378 of the cathode side gas barrier layer of the gas separator plates 312 and 312′ of FIGS. 8 and 9. Again, the crystalline glass layer of the gas barrier layer 484 would overlie the viscous glass layer of the gas barrier layer 484 in the sense that the viscous glass layer is closest to the separator body 446. The structure and formation of the gas barrier layer 484 is identical to the structure and formation of the cathode side gas barrier layer of FIGS. 8 and 9, and therefore will not be described further.

As it is formed of glass, the gas barrier layer 484 is not electrically conductive. Accordingly, it has offset passages 486 therethrough to provide electrical conduction flow paths between a current collector underlayer 482 and the anode side current collector layer 458. The passages 486 are offset relative to the feedthroughs 434, and their size, number and arrangement is identical to those of the passages 380 described with reference to the gas separator plates 312 and 312′ of FIGS. 8 and 9. They will therefore not be described further.

The current collector underlayer 482 extends over the whole of the electrode contacting zone 36 and overlies and is sealed to the enlarged feedthrough heads 454 and the gas separator plate 446. It has a thickness of about 50 μm, and its purpose is to conduct electrical current laterally across the surface of the separator body 446 to connect the feedthroughs 434 with the electrical flow path passages 486 through the gas barrier layer 484, as well as to provide lateral heat transfer across the surface of the separator body 446 to minimise the stress imparted in the separator body due to temperature variation. The underlayer 482 is formed of silver sintered from commercially pure silver powder having a particle size in the range 5 to 75 μm. Alternatively, the underlayer may be of a silver/glass composite as described previously.

Except for the fact that the material of the anode side current collector layer 458 projects into the passages 486 to provide the electrical current flow paths between the underlayer 482 and the current collector layer 458, the current collector layer 458 is essentially identical to the corresponding layers 158, 258 and 258′ described with reference to FIGS. 3 and 4, 5 and 6 respectively, and will not be described further.

The compliant layer 466 is similar to the compliant layer 266 of FIGS. 5 and 6 in that holes 470 are formed in the layer in which respective silver-barrier patches 456 are disposed in spaced manner from the compliant layer.

The arrangement and other details of the silver-barrier patches 456′ and holes 470 are identical to those of the silver-barrier patches 256 and 256′ and holes 270 of the gas separator plates 212 and 212′ of FIGS. 5 and 6, respectively, except that they overlie the passages 486 in the gas barrier layer 484 rather than the feedthroughs 434, and they will therefore not be described further.

Those skilled in the art will appreciate that the invention described herein is susceptible to variations and modifications other than those specifically described. It is to be understood that the invention includes all such variations and modifications which fall within its spirit and scope. The invention also includes all steps and features referred to or indicated in this specification, individually or collectively, and any and all combinations of any two or more of said steps or features. In particular, it will be appreciated that any feature of one embodiment of the gas separator plates described with reference to the drawings may be applied in a manner not specifically described to any of the other embodiments.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A fuel cell gas separator for use between two solid oxide fuel cells, the gas separator having a separator body with an anode side and a cathode side and with paths of electrically conductive material therethrough from the anode side to the cathode side in an electrode contacting zone of the separator, the electrically conductive material being Ag or a silver-containing material, an anode side coating over the electrode contacting zone comprising an anode side current collector layer, and a cathode side coating over the electrode contacting zone comprising a cathode side current collector layer, and wherein a respective silver-barrier patch overlies each path of electrically conductive material on the anode side, each silver-barrier patch being sufficiently dense to prevent diffusion of Ag therethrough.

2. A fuel cell gas separator according to claim 1, wherein at least one silver-barrier patch directly overlies its respective path of electrically conductive material in contact therewith.

3. A fuel cell gas separator according to claim 2, wherein said at least one silver-barrier patch is engaged with the separator body around the respective path of electrically conductive material and is electrically conductive.

4. A fuel cell gas separator according to claim 1, wherein at least one silver-barrier patch is aligned with and overlaps the respective path of electrically conductive material but is separated from the path of electrically conductive material by a layer of the anode side coating.

5. A fuel cell gas separator for use between solid oxide fuel cells, the gas separator having a separator body with an anode side and a cathode side and with paths of electrically conductive material therethrough from the anode side to the cathode side in an electrode contacting zone of the separator, the electrically conductive material being Ag or a silver-containing material, an anode side coating over the electrode contacting zone comprising an anode side current collector layer, and a cathode side coating over the electrode contacting zone comprising a cathode side current collector layer, wherein the anode side coating further comprises a gas barrier layer beneath said anode side current collector layer and an electrically conductive underlayer between said gas barrier layer and the separator body, said gas barrier layer being formed of a material that is less electrically conductive than the anode side current collector layer and the electrically conductive underlayer and having relatively electrically conductive passages therethrough from the anode side current collector layer to the electrically conductive underlayer which are offset relative to the paths of electrically conductive material through the separator body, wherein the electrically conductive underlayer electrically connects all of the paths of electrically conductive material through the separator body with all of the electrically conductive passages through the gas barrier layer, and wherein a respective silver-barrier patch is associated with each of said relatively electrically conductive passages through said gas barrier layer, each silver-barrier patch being sufficiently dense to prevent diffusion of Ag therethrough.

6. A fuel cell gas separator according to claim 5, wherein the material of the gas barrier layer is glass.

7. A fuel cell gas separator according to claim 5, wherein the relatively electrically conductive material in the passages through the gas barrier layer is selected from one or more of the material of the electrically conductive underlayer and the material of the current collector layer of the anode side coating.

8. A fuel cell gas separator according to claim 5, wherein the material of the electrically conductive underlayer comprises silver.

9. A fuel cell gas separator according to claim 1, wherein the material of the anode side current collector layer is nickel.

10. A fuel cell gas separator according to claim 1, wherein the anode side coating further comprises an outermost compliant layer that directly overlies the anode side current collector layer.

11. A fuel cell gas separator according to claim 10, wherein the compliant layer comprises nickel having a porosity in the range of 10-50 vol %.

12. A fuel cell gas separator according to claim 1, wherein the material of the separator body is an ionic conductor and the anode side coating comprises an ion barrier layer that extends in contact with the separator body over the electrode contacting zone except for an opening at each path of electrically conductive material.

13. A fuel cell gas separator according to claim 12, wherein the material of the ion barrier layer is selected from titania, alumina and glass.

14. A fuel cell gas separator according to claim 1, wherein at least one path of electrically conductive material includes an enlarged head on one or both of the anode side and cathode side.

15. A fuel cell gas separator according to claim 1, wherein the cathode side current collector layer is compliant and has a porosity in the range of 10-50 vol %.

16. A fuel cell gas separator according to claim 1, wherein a respective sealing patch is provided over and in intimate sealing contact with at least one path of electrically conductive material on the cathode side, to alleviate diffusion of oxygen through the at least one path of electrically conductive material.

17. A fuel cell gas separator according to claim 16, wherein the material of the respective sealing patch is selected from glass, an electrically conductive glass/metal composite, tin and rhodium.

18. A fuel cell gas separator according to claim 1, wherein the cathode side coating comprises an oxygen barrier layer between the separator body and the cathode side current collector layer, said oxygen barrier layer being formed of a material that has a relatively low electrical conductivity and having passages therethrough formed of a material of relatively high electrical conductivity, said passages through the oxygen barrier layer being all offset relative to the paths of electrically conductive material through the separator body.

19. A fuel cell gas separator according to claim 18, wherein the cathode side coating further comprises an electrically conductive underlayer between the separator body and the oxygen barrier layer.

20. A fuel cell gas separator for use between two solid oxide fuel cells, the gas separator having a separator body with an anode side and a cathode side and with paths of electrically conductive material therethrough from the anode side to the cathode side in an electrode contacting zone of the separator, the electrically conductive material being Ag or a silver-containing material, an anode side coating over the electrode contacting zone comprising a current collector layer and a cathode side coating over the electrode contacting zone comprising a current collector layer, and one or both of 1) an oxygen gas barrier layer on one or each of the anode side and the cathode side between the separator body and the respective current collector layer, and 2) a respective sealing patch over and in intimate sealing contact with each path of electrically conductive material on the cathode side.
